(19) United States
(12) Patent Application Publication
(10) Pub. No.: US 2025/0371162 A1
(43) Pub. Date: Dec. 4, 2025

(54) POWER SUPPLY AND DEMAND CONTROL APPARATUS, POWER SUPPLY AND DEMAND CONTROL METHOD, AND PROGRAM

(71) Applicant: NIPPON TELEGRAPH AND TELEPHONE CORPORATION, Tokyo (JP)

(72) Inventors: Yukio NAGAFUCHI, Tokyo (JP); Hiroki NAGAYAMA, Tokyo (JP); Asami MIYAJIMA, Tokyo (JP)

(21) Appl. No.: 18/852,092

(22) PCT Filed: Mar. 31, 2022
(86) PCT No.: PCT/JP2022/016781

§ 371 Date: Sep. 27, 2024

(51) Int. Cl. G06F 21/57; B60L 55/00

(52) U.S. Cl. CPC G06F 21/577; B60L 55/00; G06F 2221/034

(57) ABSTRACT

Provided is a power supply demand control device, including: a reception unit configured to collect electric vehicle information that is information on an electric vehicle and also collect power information that is information on power of a facility; a filter unit configured to determine a specific electric vehicle that is suspected of being cyberattacked based on the electric vehicle information; and a dispatch planning unit configured to determine an electric vehicle to be sent to a facility where power shortage is forecasted based on the power information from one or more electric vehicles selected among a plurality of electric vehicles for which the electric vehicle information has been collected, excluding the specific electric vehicle.

### TECHNICAL FIELD

The present invention relates to countermeasures against cyberattacks related to power supply demand control for electric vehicles (hereinafter sometimes referred to as “EVs”).

### BACKGROUND ART

In recent years, EVs have become popular. EVs can travel by being charged at a general home equipped with an EV charger, or at a charging station (also referred to as an EV charging station or EV station).

With their growing popularity, iEVs are expected to serve as power sources for buildings and homes in the future. Considering EVs as power sources, a service in which remaining battery capacity of EVs is collected at a center and distributed to homes, buildings and areas requiring power can be assumed. For example, NPLs 1 and 2 disclose examples of technologies for utilizing EVs as power sources.

### CITATION LIST

### Non Patent Literature

NPL 1: https://sei.co.jp/technology/tr/bn194/pdf/194-22. pdf, “Virtual Power Plants Applying Electric Vehicle and Plug-in Hybrid Vehicle Batteries”, January 2019, SEI Technical Review No.

194
NPL 2:

https://www.ntt.co.jp/journal/2005/files/pdf/JN20200513.pdf, “Services Provided by NTT Anode Energy”, NTT Gijutsu Journal, May 2020

### SUMMARY OF INVENTION

### Technical Problem

Many EVs have a communication function for establishing communication between the EV and various devices outside the EV. Therefore, the risk of EV-targeted cyberattacks is now increasing.

For example, EV-targeted cyberattack may compromise data integrity of information on remaining battery capacity recorded in a charging control unit installed in the EV. If the battery power data is tampered with due to cyberattacks, such an EV cannot be used as a power source.

The present invention has been made to address the foregoing problem, and an object thereof is to provide a technology for reducing the impact of cyberattacks in a system using EVs as power sources.

### Solution to Problem

According to the disclosure, provided is a power supply demand control device, including: a reception unit configured to collect electric vehicle information that is information on an electric vehicle and also collect power information that is information on power of a facility; a filter unit configured to determine a specific electric vehicle that is suspected of being cyberattacked based on the electric vehicle information;

and a dispatch planning unit configured to determine an electric vehicle to be sent to a facility where power shortage is forecasted based on the power information from one or more electric vehicles selected among a plurality of electric vehicles for which the electric vehicle information has been collected, excluding the specific electric vehicle.

### Advantageous Effects of Invention

According to the disclosure, it is possible to reduce the impact of cyberattacks in a system using EVs as power sources.

### BRIEF DESCRIPTION OF DRAWINGS

FIG. 1 is a diagram illustrating a system configuration according to an embodiment of the present invention.

FIG. 2 is a diagram illustrating an image of connection relationships between components.

FIG. 3 is a diagram illustrating an example of a hardware configuration of a device.

FIG. 4 is a flowchart illustrating an operation example of a power supply demand control device 100.

### DESCRIPTION OF EMBODIMENTS

An embodiment of the present invention (the present embodiment) will be described below with reference to the drawings. The embodiment which will be described below is merely one example and embodiments to which the present invention is applied are not limited to the following embodiment.

The scope of application of the technology according to the present invention is not limited to electricity-driven road vehicles, but broadly includes all types of electric vehicles such as motorcycles, tractors and vessels.

### System Configuration

In the present embodiment, a power supply demand control device 100 collects alert information from individual EVs in an EV cluster or VSOCs, detects EVs of which data may have been tampered with based on the alert information, and excludes EVs with suspicious data integrity from calculation of power supply demand control, thereby reducing the impact of cyberattacks. A system configuration and operations for its implementation will be described hereinbelow.

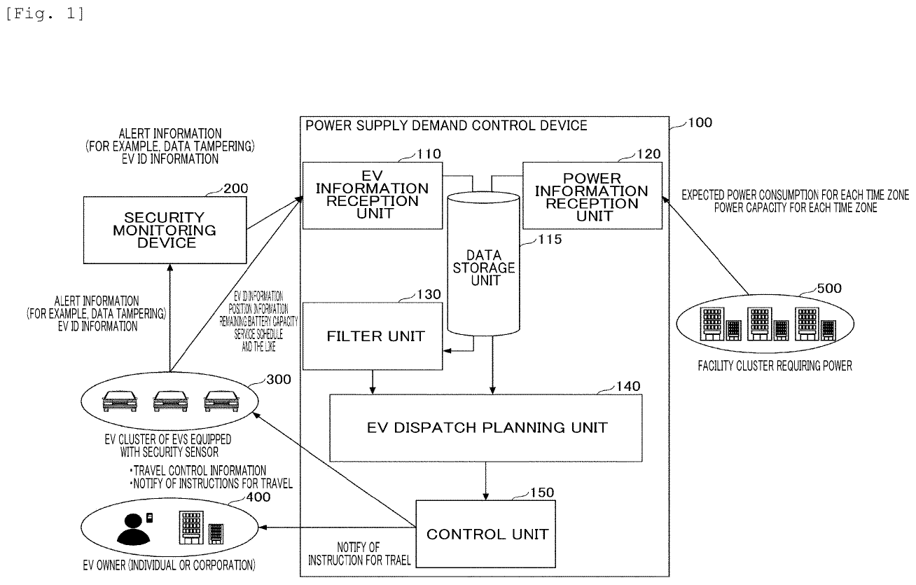

FIG. 1 shows an overall configuration of a system according to the present embodiment. As illustrated in FIG. 1, this system includes the power supply demand control device 100 (which may also be referred to as a power supply demand control system), a security monitoring device 200 (for example, vehicle security operation center (VSOC)), an EV cluster 300 of EVs equipped with security sensors, EV owners 400, and a facility cluster 500 of facilities requiring electricity. The outline of each component is as follows.

The power supply demand control device 100 is a device that performs power supply demand control such as sending (dispatching) EVs to facilities where power shortages are forecasted.

The security monitoring device 200 collects alert information from each EV equipped with a security sensor in the EV cluster 300, and transmits the collected alert information to the power supply demand control device 100. The security monitoring device 200 may acquire various logs such as communication logs and charging operation logs from each EV in the EV cluster 300, generate alert information by analyzing the logs, and transmit the generated alert information to the power supply demand control device 100.

Each EV in the EV cluster 300 is equipped with a security sensor, and outputs alert information when a cyberattack is detected. The power supply demand control device 100 collects alert information from the security monitoring device 200 in the example shown in FIG. 1, however it is merely one example. The power supply demand control device 100 may collect alert information directly from EVs.

For example, the EV owner 400 moves the EV in response to instructions from the power control device 100. More specifically, the EV owner 400 holds a terminal such as a smartphone, and instructions from the power control device 100 are transmitted to the terminal.

The facility cluster 500 is, for example, a cluster of facilities receiving power from a grid controlled by a local operator in a region where the facility cluster 500 is located. The facility cluster 500 includes office buildings, factories and plants, general households, public facilities, and charging stations (for example, chargers (EVSE)).

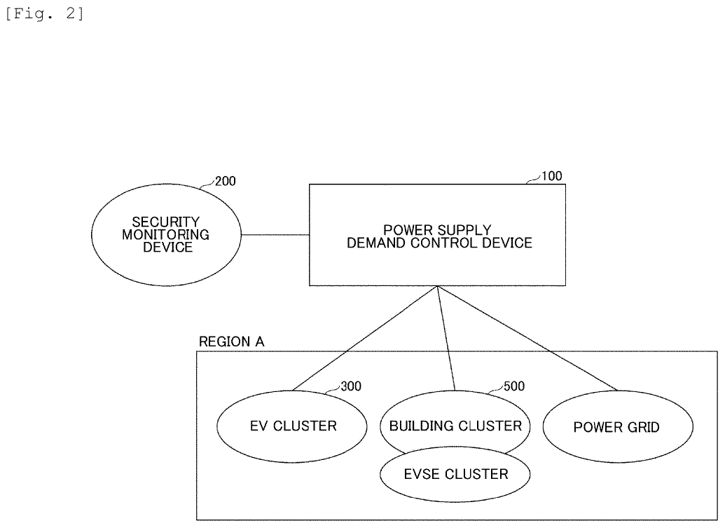

FIG. 2 is a visual representation illustrating a connection configuration of this system. In the example shown in FIG. 2, one example is illustrated in which an area assigned to the power supply demand control device 100 is indicated as region A.

### Configuration of Power Supply Demand Control Device 100

The configuration of the power supply demand control device 100 will be described below. As illustrated in FIG. 1, the power supply demand control device 100 includes an EV information reception unit 110, a data storage unit 115, a power information reception unit 120, a filter unit 130, an EV dispatch planning unit 140 and a control unit 150. The power supply and demand control device 100 may not include the control unit 150 and a device corresponding to the control unit 150 may be provided outside the power supply demand control device 100. Operations of the respective units will be described later. The EV information reception unit 110 and the power information reception unit 120 may be collectively referred to as a “reception unit.”

The power supply demand control device 100 can be implemented, for example, by causing a computer to execute a program. In other words, the power supply demand control device 100 can be implemented by executing a program corresponding to the processing executed by the power supply demand control device 100 using hardware resources such as a CPU and a memory built in a computer. The program can be recorded on a computer-readable recording medium (for example, portable memory) to be stored and distributed. The foregoing program can also be provided through a network such as the Internet or email.

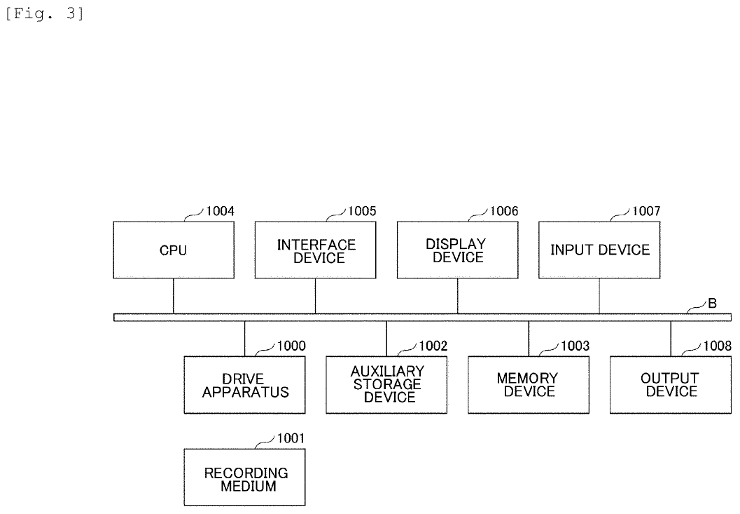

FIG. 3 is a diagram illustrating an exemplary hardware configuration of the computer. The computer shown in FIG. 3 has, for example, a drive device 1000, an auxiliary storage device 1002, a memory device 1003, a CPU 1004, an interface device 1005, a display device 1006, an input device 1007, and an output device 1008, which are connected to each other via a bus BS.

A program to implement processing in the computer is provided by, for example, a recording medium 1001 such as a CD-ROM or a memory card. When the recording medium 1001 having the program stored therein is set in the drive device 1000, the program is installed in the auxiliary storage device 1002 from the recording medium 1001 via the drive device 1000. However, the program does not have to be installed from the recording medium 1001 and may be downloaded from another computer via a network. The auxiliary storage device 1002 stores the installed program and also stores, for example, required files and data.

The memory device 1003 reads out and stores the program from the auxiliary storage device 1002 when receiving an instruction to activate the program. The CPU 1004 implements functions related to the control device 100 according to the program stored in the memory device 1003. The interface device 1005 is used as an interface for connecting to, for example, a network. The display device 1006 displays, for example, a graphical user interface (GUI) according to the program. The input device 1007 is configured by, for example, a keyboard and mouse, buttons or touchscreen and is used for allowing users to input various operational instructions. The output device 1008 outputs calculation results.

The power supply demand control device 100 may be implemented by a single computer or multiple computers. Further, the power supply demand control device 100 may be implemented by a physical machine or virtual machine on a cloud.

### Exemplified Operations of Power Supply Demand Control Device 100

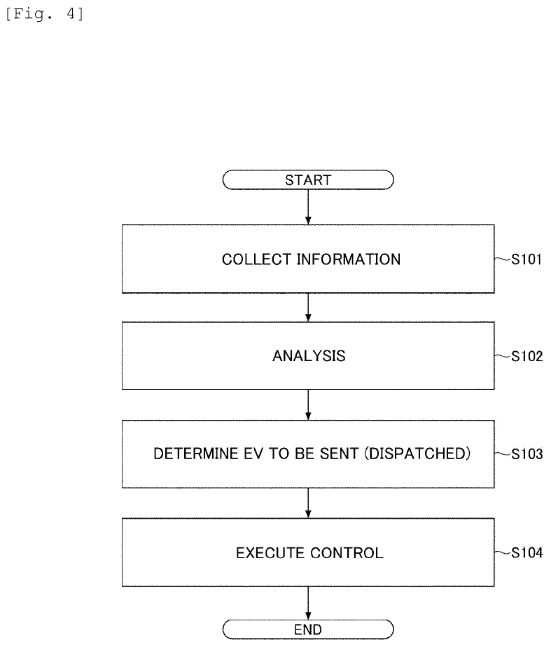

Next, exemplified operations of the power supply demand control device 100 according to a procedure of the flowchart shown in FIG. 4. FIG. 4 shows processing throughout steps from information collection to execution of certain control.

### S101: Collect Information

In S101, the EV information reception unit 110 collects EV information of each EV in the EV cluster 300. The EV information is collected, for example, periodically (at certain time intervals). The collected EV information is stored in the data storage unit 115.

The EV information of each EV includes, for example, its “location information, remaining battery capacity, ID, vehicle type, service schedule, and alert information.” ID is a unique identifier that can identify the EV. The service schedule is information including the date and time when the EV will be in service. The service schedule may be collected from the EV user's terminal, or alternatively, from charging reservation apps.

The alert information includes, for example, information indicating that a cyberattack has been detected. EV information for EVs in which no cyberattack was detected does not include alert information.

The alert information may include information indicating which part (unit) got cyber attacked, and information indicating the type of cyberattack (for example, data tampering or data manipulation).

The power information reception unit 120 collects power information from each facility of the facility cluster 500 in the area assigned to the power supply demand control device 100. The power information is collected, for example, periodically (at certain time intervals). The collected power information is stored in the data storage unit 115.

The power information for each facility includes, for example, the facility's identification information, power capacity at the current time, power capacity (forecasting) at each time of a period from the current time to a certain time in the future, current power demand (which may be referred to as “power consumption”) and power demand (forecasting) at each time of a period from the current time to a certain time in the future. It is assumed that the location of each facility is known.

The interval between each time may be, for example, 1 minute, 10 minutes, 30 minutes, 1 hour, or other times. The “power capacity” is the maximum power that is available for the facility.

### S102: Analysis

In S102, the filter unit 130 reads the EV information of each EV from the data storage unit 115, and based on the read EV information, specifies EVs that are suspected of being cyberattacked (EVs of which, for example, data is compromised), and notifies the EV dispatch planning unit 140 of the ID of such an EV.

The EV that is suspected of being cyberattacked is, for example, an EV whose EV information includes alert information indicating that a cyberattack has been detected. Even if the EV information of a certain EV includes alert information indicating that a cyberattack has been detected, in a case where the alter information is determined that it is unrelated to compromised data integrity for remaining battery capacity, the ID of such an EV does not have to be notified to the EV dispatch planning unit 140.

The EV information reception unit 110 may also collect information on the vulnerabilities of EVs to cyberattacks disclosed by, for example, vehicle manufacturers and security providers, and store the information in the data storage unit 115. In this case, based on the public information that vulnerability has been found in a specific vehicle model, the filter unit 130 may understand the EV corresponding to the specific vehicle model as the “EV that is suspected of being cyberattacked,” specify the EV from the EV information, and not transmit the ID of the specified EV to the EV dispatch planning unit 140.

### S103: Determine EVs to be Dispatched

In S103, the EV dispatch planning unit 140 reads out the power information of each facility from the data storage unit 115, and identifies facilities where power shortages are forecasted. For example, if the statement “power demand>power capacity X α” is true at a certain time in the future at a certain facility, it can be forecasted that the facility will experience a power shortage during a period covering the certain time. α is a coefficient for considering safety, and satisfies 0<α<1. The coefficient a may not be required. Furthermore, “facilities where power shortages are forecasted” include facilities that are experiencing power shortages at the current time.

The EV dispatch planning unit 140 reads out from the data storage unit 115 the EV information of the EVs excluding the EV with the ID notified from the filter unit 130, and determines an EV to be sent (dispatched) to a facility where power shortage is forecasted, based on, for example, location information, remaining battery capacity and service schedule, all contained in the read EV information of each EV.

For example, the EV dispatch planning unit 140 determines an EV which has remaining battery capacity not less than a threshold and is not scheduled to be in service during a period when power shortage is forecasted at a facility, as an EV which should be sent to a facility where power shortage is forecasted. If there are a plurality of EVs, each of which has remaining battery capacity not more than a threshold and is not scheduled to be in service during a period when power shortage is forecasted at a facility, the EV dispatch planning unit 140 select an EV closest to the facility among those EVs.

### S104: Control

In S104, the control unit 150 controls to send (dispatch) an EV to a facility where power shortage is forecasted. Examples of control include (1) and (2) below.

(1) If an EV is a self-driving vehicle, the control unit 150 transmits control information to the EV instructing it to travel to the designated facility.

(2) If the EV is not a self-driving vehicle, the control unit 150 notifies an EV driver or EV owner of instructions for the EV to travel to the designated facility.

### Advantageous Effects of Embodiment

With the disclosure describe above, it is possible to identify EVs that are suspected of being cyberattacked and reduce the impact of cyberattacks by excluding those EVs from potential power sources in the system using EVs as power sources.

### Supplements

The following supplements are disclosed in relation to the embodiment described above.

### Supplement 1

A power supply demand control device, including:
a memory; and
at least one processor connected to the memory,
wherein the processor executes:
collecting electric vehicle information that is information on an electric vehicle and also collecting power information that is information on power of a facility;
determining a specific electric vehicle that is suspected of being cyberattacked based on the electric vehicle information; and
determining an electric vehicle to be sent to a facility where power shortage is forecasted based on the power information from one or more electric vehicles selected among a plurality of electric vehicles for which the electric vehicle information has been collected, excluding the specific electric vehicle.

### Supplement 2

The power supply demand control device as set forth in Supplement 1, wherein the processor executes: determining the specific electric vehicle based on alert information included in the electric vehicle information, or alternatively, determining the specific electric vehicle based on public information on vulnerability to cyberattacks and vehicle type information included in the electric vehicle information.

### Supplement 3

The power supply demand control device as set forth in Supplement 1 or 2, wherein the processor executes: determining a facility where power shortage is forecasted based on power capacity and power demand for each facility, which are included in the power information.

### Supplement 4

A power supply demand control method executed by a computer, the method including: collecting electric vehicle information that is information on an electric vehicle and also collecting power information that is information on power of a facility; determining a specific electric vehicle that is suspected of being cyberattacked based on the electric vehicle information; and determining an electric vehicle to be sent to a facility where power shortage is forecasted based on the power information from one or more electric vehicles selected among a plurality of electric vehicles for which the electric vehicle information has been collected, excluding the specific electric vehicle.

### Supplement 5

A non-transitory storage medium strong a program executable by a computer to execute power supply demand control processing, the power supply demand control processing including: collecting electric vehicle information that is information on an electric vehicle and also collecting power information that is information on power of a facility; determining a specific electric vehicle that is suspected of being cyberattacked based on the electric vehicle information; and determining an electric vehicle to be sent to a facility where power shortage is forecasted based on the power information from one or more electric vehicles selected among a plurality of electric vehicles for which the electric vehicle information has been collected, excluding the specific electric vehicle.

Although the embodiment has been described above, the present invention is not limited to the specific embodiment, and various modifications and alterations can be made without departing from the scope of the present invention defined in the claims.

### REFERENCE SIGNS LIST

100 Power supply demand control device
110 EV information reception unit
115 Data storage unit
120 Power information reception unit
130 Filter unit
140 EV dispatch planning unit
150 Control unit
200 Security monitoring device
300 EV cluster
400 EV owner
500 Facility cluster
1000 Drive device
1001 Recording medium
1002 Auxiliary storage device
1003 Memory device
1004 CPU
1005 Interface device
1006 Display device
1007 Input device
1008 Output device

1. A power supply demand control device, comprising:
a memory; and
a processor coupled to the memory and configured to:
collect electric vehicle information that is information on an electric vehicle and also collect power information that is information on power of a facility;
determine a specific electric vehicle that is suspected of being cyberattacked based on the electric vehicle information; and
determine an electric vehicle to be sent to a facility where power shortage is forecasted based on the power information from one or more electric vehicles selected among a plurality of electric vehicles for which the electric vehicle information has been collected, excluding the specific electric vehicle.

2. The power supply demand control device according to claim 1, wherein the processor is configured to determine the specific electric vehicle based on alert information included in the electric vehicle information, or alternatively, determine the specific electric vehicle based on public information on vulnerability to cyberattacks and vehicle type information included in the electric vehicle information.

3. The power supply demand control device according to claim 1, wherein the processor is configured to determine a facility where power shortage is forecasted based on power capacity and power demand for each facility, which are included in the power information.

4. A power supply demand control method executed by a computer, the method comprising:
collecting electric vehicle information that is information on an electric vehicle and also collecting power information that is information on power of a facility;
determining a specific electric vehicle that is suspected of being cyberattacked based on the electric vehicle information; and
determining an electric vehicle to be sent to a facility where power shortage is forecasted based on the power information from one or more electric vehicles selected among a plurality of electric vehicles for which the electric vehicle information has been collected, excluding the specific electric vehicle.

5. A non-transitory computer-readable recording medium storing a program for causing a computer to perform the method of claim 4.
